(19) United States
(12) Patent Application Publication
(10) Pub. No.: US 2025/0202364 A1
(43) Pub. Date: Jun. 19, 2025

(54) BIDIRECTIONAL THREE-LEVEL BUCK-BOOST VOLTAGE CONVERTER WITH BATTERY CHARGING

(71) Applicant: Renesas Electronics America Inc., Milpitas, CA (US)

(72) Inventors: Shahriar Jalal NIBIR, Apex, NC (US); Rahul RAMESH, Cary, NC (US); Yen-Mo CHEN, Morrisville, NC (US); Sungkeun LIM, Apex, NC (US); Gary KIDWELL, Milpitas, CA (US)

(73) Assignee: Renesas Electronics America Inc., Milpitas, CA (US)

(21) Appl. No.: 18/545,222

(22) Filed: Dec. 19, 2023

(51) Int. Cl. H02M 3/158

(52) U.S. Cl. CPC H02M 3/1582

(57) ABSTRACT

Apparatuses, devices, and methods for operating a voltage converter are described. A semiconductor device can include a first switching circuit comprising four switches and a flying capacitor. The semiconductor device can further include a second switching circuit comprising two switches. The semiconductor device can further include an inductor connected between a first phase node of the first switching circuit to a second phase node of the second switching converter. The first switching circuit and the second switching circuit can be combined to implement a buck-boost voltage converter that performs voltage conversion in a first direction from the first phase node to the second phase node and in a second direction from the second phase node to the first phase node.

### BACKGROUND

The present disclosure relates in general to semiconductor devices. More specifically, the present disclosure relates to topologies for a bidirectional three-level buck-boost voltage converter with battery charging.

Voltage converters, such as buck converters and boost converters, can be used for converting an input voltage to an output voltage having a different voltage level. A buck converter, or step-down converter, can be used in applications where there is a need to decrease a direct current (DC) voltage. The buck converter can receive an input voltage and provide a stepped-down output voltage. A boost converter, or step-up converter, can be used in applications where there is a need to increase a DC voltage. The boost converter can receive an input voltage and provide a stepped-up output voltage. A voltage converter can include multiple switches at an input of the voltage converter, where the switches can be turned on and off by a pulse width modulated (PWM) control signal. A duty cycle of the PWM control signal can determine an output voltage of the voltage converter. As the switches turn on and off, they modulate a DC input voltage and the modulated voltage can be provided to an inductor. The inductor can be connected to a capacitor and the modulated voltage can be a time-varying voltage that causes the inductor to create a time-varying current. The interaction of the inductor and capacitor with the time-varying voltage and current can produce a nearly constant output voltage that has a different DC level than the input voltage.

A voltage converter with two switches can switch the inductor between two voltages—the input voltage and ground. A multi-level voltage converter can include more than two switches and can switch the inductor among more than two voltages—the input voltage, at least one intermediate voltage between the input voltage and ground, and ground. For example, a three-level voltage converter can include four switches and can switch the inductor among three voltages—the input voltage, a mid-voltage equivalent to half the input voltage, and ground. Multi-level voltage converters include at least one flying capacitor that is switched between two states-a charging state and a discharging state.

### SUMMARY

In one embodiment, a semiconductor device is generally described. The semiconductor device can include a first switching circuit comprising four switches and a flying capacitor. The semiconductor device can further include a second switching circuit comprising two switches. The semiconductor device can further include an inductor connected between a first phase node of the first switching circuit to a second phase node of the second switching converter. The first switching circuit and the second switching circuit can be combined to implement a buck-boost voltage converter that performs voltage conversion in a first direction from the first phase node to the second phase node and in a second direction from the second phase node to the first phase node.

In one embodiment, a system is generally described. The system can include a controller and a circuit. The circuit can include a first switching circuit comprising four switches and a flying capacitor. The circuit can further include a second switching circuit comprising two switches. The circuit can further include an inductor connected between a first phase node of the first switching circuit to a second phase node of the second switching converter. The controller can be configured to operate the circuit as a buck-boost converter that performs voltage conversion in a first direction from the first phase node to the second phase node and in a second direction from the second phase node to the first phase node.

In one embodiment, a system is generally described. The system can include a battery, a controller and a circuit. The circuit can include a first switching circuit comprising four switches and a flying capacitor. The circuit can further include a second switching circuit comprising two switches. The circuit can further include an inductor connected between a first phase node of the first switching circuit to a second phase node of the second switching converter. The controller can be configured to operate the circuit as a buck-boost converter that performs voltage conversion in a first direction from the first phase node to the second phase node to charge the battery. The controller can be further configured to operate the circuit as a buck-boost converter that performs voltage conversion in a second direction from the second phase node to the first phase node to discharge the battery.

Further features as well as the structure and operation of various embodiments are described in detail below with reference to the accompanying drawings. In the drawings, like reference numbers indicate identical or functionally similar elements.

### BRIEF DESCRIPTION OF THE DRAWINGS

FIG. 1 is an example diagram of a semiconductor device that can implement bidirectional three-level buck-boost voltage converter with battery charging in one embodiment.

FIG. 2 is a diagram showing a set of signal waveforms of bidirectional three-level buck-boost voltage converter with battery charging in one embodiment.

FIG. 3 is a diagram showing another set of signal waveforms of bidirectional three-level buck-boost voltage converter with battery charging in one embodiment.

FIG. 4 is a diagram showing another set of signal waveforms of bidirectional three-level buck-boost voltage converter with battery charging in one embodiment.

FIG. 5 is a diagram showing another set of signal waveforms of bidirectional three-level buck-boost voltage converter with battery charging in one embodiment.

FIG. 6 is a diagram showing another set of signal waveforms of bidirectional three-level buck-boost voltage converter with battery charging in one embodiment.

FIG. 7 is a diagram showing another set of signal waveforms of bidirectional three-level buck-boost voltage converter with battery charging in one embodiment.

FIG. 8 is a diagram showing a configuration of bidirectional three-level buck-boost voltage converter with battery charging in one embodiment.

FIG. 9 is a diagram showing another configuration of bidirectional three-level buck-boost voltage converter with battery charging in one embodiment.

FIG. 10 is a diagram showing another configuration of bidirectional three-level buck-boost voltage converter with battery charging in one embodiment.

FIG. 11 is a diagram showing another configuration of bidirectional three-level buck-boost voltage converter with battery charging in one embodiment.

FIG. 12 is a diagram showing another configuration of bidirectional three-level buck-boost voltage converter with battery charging in one embodiment.

FIG. 13 is a diagram showing another configuration of bidirectional three-level buck-boost voltage converter with battery charging in one embodiment.

FIG. 14 is a diagram showing another configuration of bidirectional three-level buck-boost voltage converter with battery charging in one embodiment.

FIG. 15 is a diagram showing another configuration of bidirectional three-level buck-boost voltage converter with battery charging in one embodiment.

FIG. 16 is a diagram showing an example application of bidirectional three-level buck-boost voltage converter with battery charging in one embodiment.

### DETAILED DESCRIPTION

In the following description, numerous specific details are set forth, such as particular structures, components, materials, dimensions, processing steps and techniques, in order to provide an understanding of the various embodiments of the present application. However, it will be appreciated by one of ordinary skill in the art that the various embodiments of the present application may be practiced without these specific details. In other instances, well-known structures or processing steps have not been described in detail in order to avoid obscuring the present application.

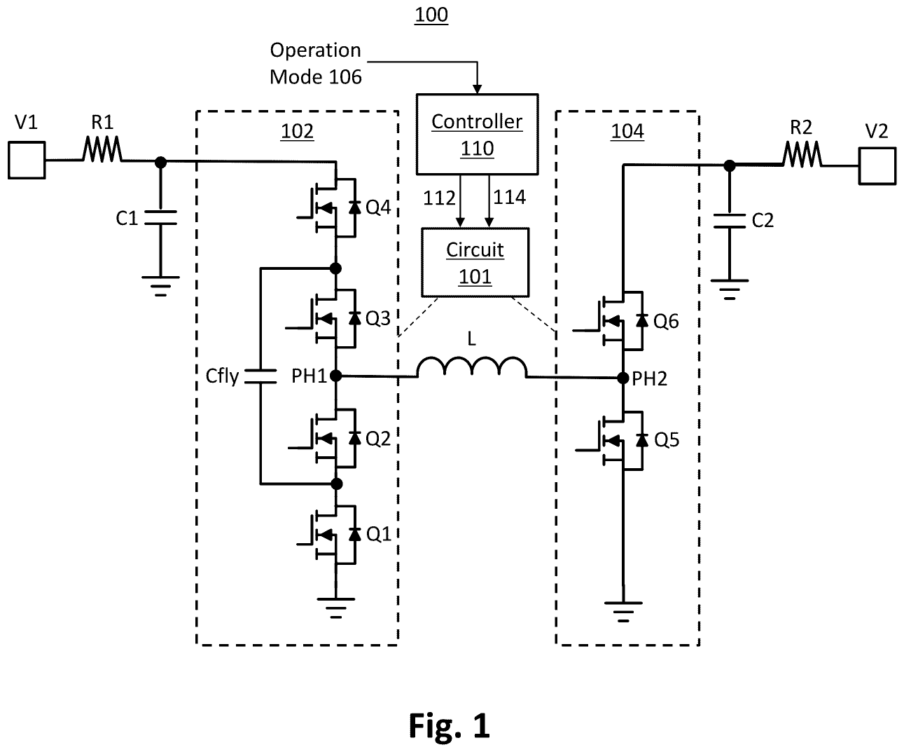

FIG. 1 is an example diagram of a system that can implement bidirectional three-level buck-boost voltage converter with battery charging in one embodiment. System 100 shown in FIG. 1A can be a part of a voltage converter. System 100 can be implemented by one or more semiconductor devices in semiconductor package. System 100 can include a circuit 101 and a controller 110. Circuit 101 can include a switching circuit 102 and a switching circuit 104. In one embodiment, switching circuit 102 can implement a three-level buck converter and switching circuit 104 can implement a two-level boost converter.

Switching circuit 102 can include four switches Q1, Q2, Q3, Q4 and a flying capacitor Cfly. Switches Q1, Q2, Q3, Q4 can be, for example, metal-oxide-semiconductor field-effect transistors (MOSFETs). Switches Q1, Q2 can be referred to as a first low-side (LS) switch and a second LS switch, respectively. Switches Q3, Q4 can be referred to as a first high-side (HS) switch and a second HS switch, respectively. Switches Q1, Q2, Q3, Q4 in switching circuit 102 can be switched to control current flowing into, or out of, a switch node or phase node PH1. The timing and duty cycle of drive signals being used for controlling switches Q1, Q2, Q3, Q4 in switching circuit 102 can maintain a flying capacitor voltage VCfly (e.g., a voltage across flying capacitor Cfly) at half the input voltage. By maintaining the flying capacitor voltage at half the input voltage, the voltage at PH1 can alternate between the input voltage, half the input voltage, and ground (GND) or 0V.

Switching circuit 104 can include two switches Q5, Q6. Switches Q5, Q6 can be, for example, MOSFETs. Switch Q5 can be a LS switch and switch Q6 can be a HS switch. Switches Q5, Q6 in switching circuit 104 can be switched to control current flowing into, or out of, a switch node or phase node PH2. An inductor L can be connected between phase nodes PH1 and PH2. Switches in switching circuits 102, 104 can be controlled in order to control current flowing through inductor L. Current can flow through inductor L in either direction, e.g., from PH1 to PH2 or from PH2 to PH1.

Switching circuit 102 and switching circuit 104 can be combined in circuit 101 to implement a 3-level bi-directional buck-boost converter. The 3-level bi-directional buck-boost converter implemented by circuit 101 can be used in various applications, such as battery chargers. In one embodiment, an input voltage can be V1 and circuit 101 can convert voltage V1 into V2, where current can flow from PH1 to PH2. In another embodiment, an input voltage can be V2 and circuit 101 can convert voltage V2 into V1, where current can flow from PH2 to PH1.

Conventional buck-boost converters can include a 4-FET topology (e.g., H-bridge) that can implement two-level buck-boost voltage conversion. The 6-FET topology disclosed in the present disclosure can implement three-level buck-boost voltage conversion. The three-level buck-boost voltage conversion can reduce switching loss, which leads to improved efficiency and improved thermal management when compared to conventional 4-FET topology. Further, utilization of the 3-level buck-boost voltage converter in the 6-FET topology can also reduce harmonic distortion and are more suitable for handling higher voltages when compared to a 4-FET topology.

To be described in more detail below, controller 110 can control circuit 101 to switch under different sequences, different timings and different duty cycles to operate circuit 101 as different types of voltage converters. Controller 110 can be configured to individually control switching circuits 102, 104 by using different set of control signals. By way of example, controller 110 can be configured to generate one or more control signals 112, 114. Control signal 112 can include one or more pulse width modulation (PWM) signals that can define switching sequences and duty cycles of switches Q1, Q2, Q3, Q4 in switching circuit 102. Control signal 114 can include one or more PWM signals that can define switching sequences and duty cycles of switches Q5, Q6 in switching circuit 104. Controller 110 can provide the PWM control signals to one or more gate drivers (not shown) and the gate drivers can use the PWM control signals to generate gate voltages for driving switching circuits 102, 104. In one embodiment, controller 110 can receive a command indicating an operation mode 106. Operation mode 106 can include, but not limited to, buck converter (two or three level), boost converter (two or three level), buck-boost converter (two or three level), pass through mode, various voltage converter modes with or without isolation and/or different output voltage ranges, or other voltage converter modes. Controller 110 can generate control signals 112, 114 based on operation mode 106. Further, in some embodiments, to operate circuit 101 as different types of voltage converters, one or more components can be removed or put into a do not populate (DNP) state. Controller 110 can continue to control circuit 101 after the removal of components without modifications to the functionalities of controller 110.

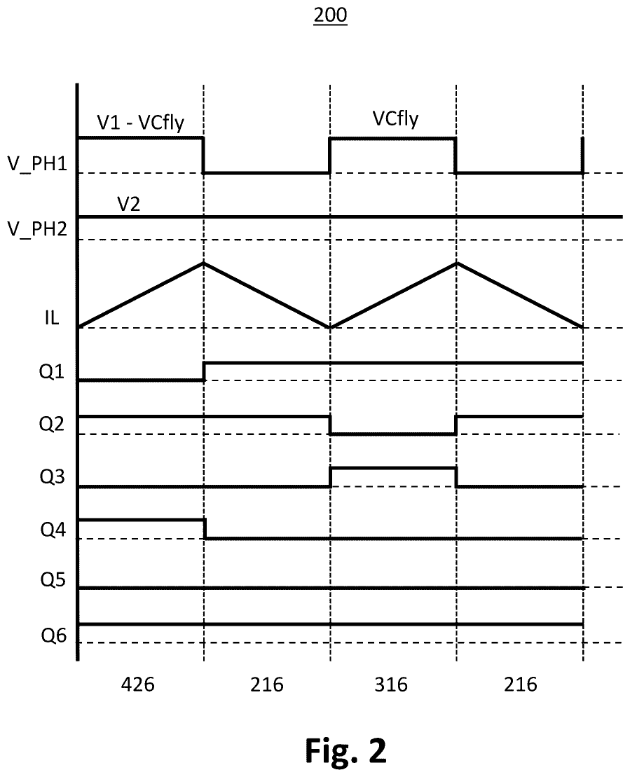

FIG. 2 is a diagram showing a set of signal waveforms of bidirectional three-level buck-boost voltage converter with battery charging in one embodiment. Description of FIG. 2 can reference components shown in FIG. 1. A set of signal waveforms showing a switching sequence 200 performed by controller 110 to control circuit 101 is shown in FIG. 2. Switching sequence 200 can be performed under an operation mode where circuit 101 operates as a three-level buck voltage converter to convert an input voltage into an output voltage having a low voltage range (e.g., less than half the input voltage). In one embodiment, operation mode 106 can indicate a three-level buck voltage converter with low output voltage range and controller 110 can generate control signals 112, 114 having PWM signals that vary according to switching sequence 200. In the example shown in FIG. 2, V1 can be input voltage and V2 can be the output voltage such that the inductor current IL can flow from PH1 to PH2. In switching sequence 200, Q6 can remain turned on, Q5 can remain turned off, and controller 110 can perform switching sequence 200 repetitively by turning on state 426 (e.g., Q4, Q2, Q6 turned on), then state 216, then state 316, then state 216.

At state 426, switches Q4, Q2, Q6 are turned on and switches Q1, Q3 and Q5 are turned off. Also at state 426, the inductor current IL can increase, the voltage at phase node PH1 (V_PH1) can be V1-VCfly and the voltage at phase node PH2 (V_PH2) can be V2. At state 216, switches Q2, Q1, Q6 are turned on and switches Q3, Q4, Q5 are turned off. Also at state 216, the inductor current IL can decrease, V_PH1 can be zero and V_PH2 can remain at V2. At state 316, switches Q3, Q1, Q6 are turned on and switches Q2, Q4, Q5 are turned off. Also at state 316, the inductor current IL can increase, V_PH1 can be VCfly and V_PH2 can remain at V2. Switching sequence 200 can allow circuit 101 to operate under a steady state balanced condition where VCfly can be maintained at V1/2.

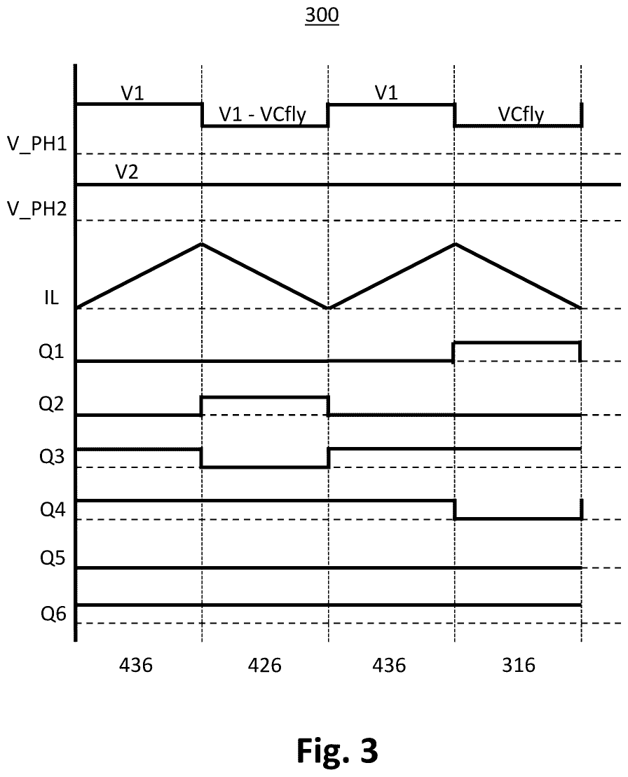

FIG. 3 is a diagram showing another set of signal waveforms of bidirectional three-level buck-boost voltage converter with battery charging in one embodiment. Description of FIG. 3 can reference components shown in FIG. 1 to FIG. 2. A set of signal waveforms showing a switching sequence 300 performed by controller 110 to control circuit 101 is shown in FIG. 3. Switching sequence 300 can be performed under an operation mode where circuit 101 operates as a three-level buck voltage converter to convert an input voltage into an output voltage having a high voltage range (e.g., greater than half the input voltage and less than the input voltage). In one embodiment, operation mode 106 can indicate a three-level buck voltage converter with high output voltage range and controller 110 can generate control signals 112, 114 having PWM signals that vary according to switching sequence 300. In the example shown in FIG. 2, V1 can be input voltage and V2 can be the output voltage such that the inductor current IL can flow from PH1 to PH2. In switching sequence 300, Q6 can remain turned on and Q5 can remain turned off, and controller 110 can perform switching sequence 300 repetitively by turning on state 436, then state 426, then state 436, then state 316.

At state 436, switches Q4, Q3, Q6 are turned on and switches Q1, Q2 and Q5 are turned off. Also at state 436, the inductor current IL can increase, V_PH1 can be V1 and the V_PH2 can be V2. State 426 and state 316 are described above with respect to FIG. 2. Switching sequence 300 can allow circuit 101 to operate under a steady state balanced condition where VCfly can be maintained at V2/2.

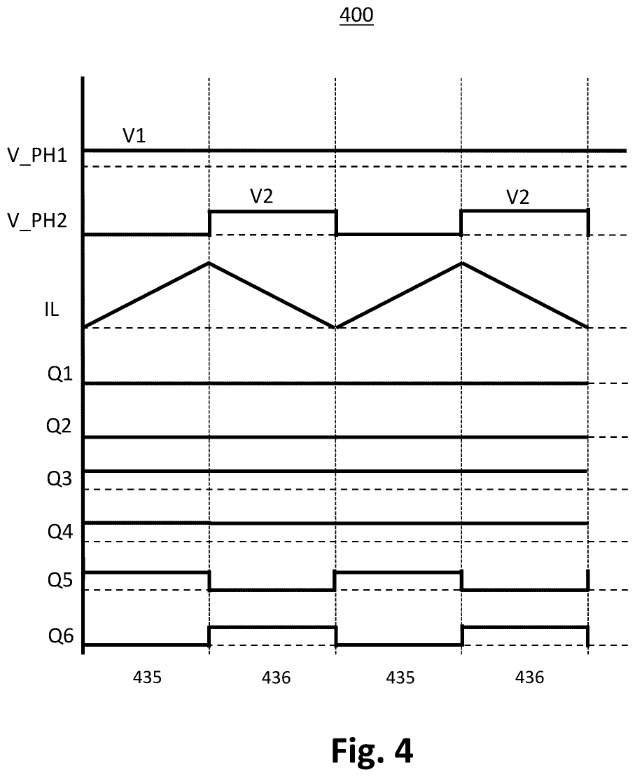

FIG. 4 is a diagram showing another set of signal waveforms of bidirectional three-level buck-boost voltage converter with battery charging in one embodiment. Description of FIG. 2 can reference components shown in FIG. 1 to FIG. 3. A set of signal waveforms showing a switching sequence 400 performed by controller 110 to control circuit 101 is shown in FIG. 4. Switching sequence 400 can be performed under an operation mode where circuit 101 operates as a boost voltage converter to convert an input voltage into a higher output voltage. In one embodiment, operation mode 106 can indicate a two-level boost voltage converter and controller 110 can generate control signals 112, 114 having PWM signals that vary according to switching sequence 400. In the example shown in FIG. 4, V1 can be input voltage and V2 can be the output voltage such that the inductor current IL can flow from PH1 to PH2. When circuit 101 operates as a boost voltage converter, switches Q3, Q4 remains turned on and V_PH1 is the same as V1. Controller 110 can perform switching sequence 400 repetitively by turning on switches Q4, Q3, Q5 (“state 435”) and then switches Q4, Q3, Q6 (“state 436”). At state 435, switches Q4, Q3, Q5 are turned on and switches Q1, Q2 and Q6 are turned off. Also at state 435, the inductor current IL can increase, V_PH1 can be V1 and V_PH2 can be zero.

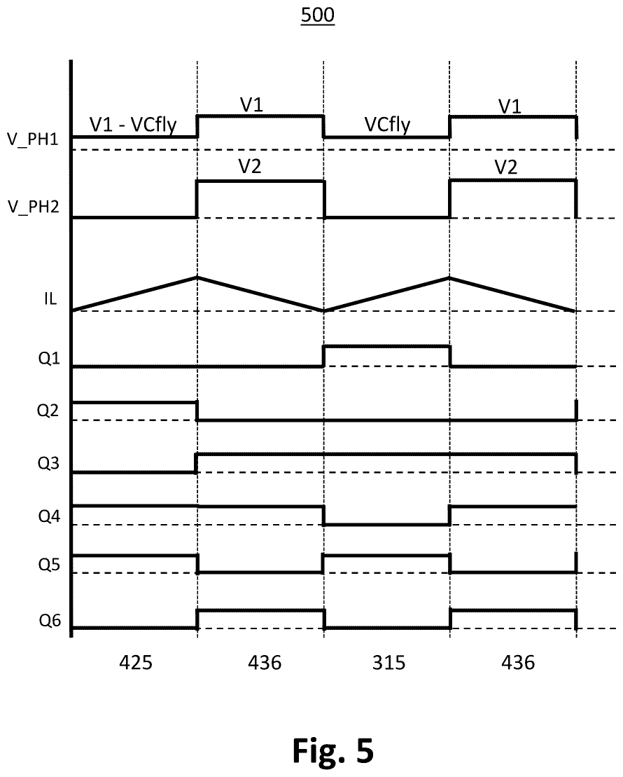

FIG. 5 is a diagram showing another set of signal waveforms of bidirectional three-level buck-boost voltage converter with battery charging in one embodiment. Description of FIG. 2 can reference components shown in FIG. 1 to FIG. 4. A set of signal waveforms showing a switching sequence 500 performed by controller 110 to control circuit 101 is shown in FIG. 5. Switching sequence 500 can be performed under an operation mode where circuit 101 operates as a boost voltage converter to convert an input voltage into a higher output voltage. In one embodiment, operation mode 106 can indicate a two-level boost voltage converter and controller 110 can generate control signals 112, 114 having PWM signals that vary according to switching sequence 500. In the example shown in FIG. 5, V1 can be input voltage and V2 can be the output voltage such that the inductor current IL can flow from PH1 to PH2. Switching sequence 500 can repetitively turn on state 425, state 436, state 315 then state 436.

At state 425, switches Q4, Q2, Q5 are turned on and switches Q1, Q3 and Q6 are turned off. Also at state 425, the inductor current IL can increase, V_PH1 can be V1-VCfly and V_PH2 can be zero. At state 315, switches Q3, Q1, Q5 are turned on and switches Q2, Q4 and Q6 are turned off. Also at state 315, the inductor current IL can increase, V_PH1 can be VCfly and V_PH2 can be zero. State 436 is described above with respect to FIG. 3.

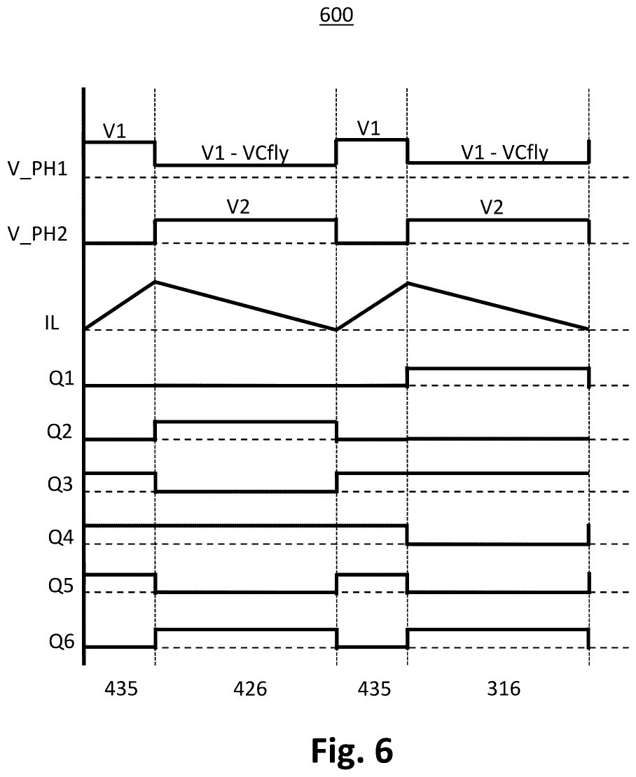

FIG. 6 is a diagram showing another set of signal waveforms of bidirectional three-level buck-boost voltage converter with battery charging in one embodiment. Description of FIG. 2 can reference components shown in FIG. 1 to FIG. 5. A set of signal waveforms showing a switching sequence 600 performed by controller 110 to control circuit 101 is shown in FIG. 6. Switching sequence 600 can be performed under an operation mode where circuit 101 operates as a three-level buck-boost voltage converter to convert an input voltage into a higher output voltage. In one embodiment, operation mode 106 can indicate a three-level buck-boost voltage converter to step up (e.g., boost) an input voltage and controller 110 can generate control signals 112, 114 having PWM signals that vary according to switching sequence 600. In the example shown in FIG. 6, V1 can be input voltage and V2 can be the output voltage such that the inductor current IL can flow from PH1 to PH2. Controller 110 can perform switching sequence 600 repetitively by turning on state 435, state 426, state 435 then state 316. In the embodiment shown in FIG. 6, states 426, 316 can remain turned on for a longer duration than state 435.

In the example shown in FIG. 6, since circuit 101 is being operated as a buck-boost converter to convert the input voltage into a higher output voltage, the discharge rate of inductor L (e.g., decreasing rate of inductor current IL) is relatively slower than the charge rate of inductor L (e.g., increasing rate of the inductor current IL). To discharge inductor L slower than the charge rate of the inductor L, durations of states 426, 316 can be longer than durations of state 435. If circuit 101 is being operated as a buck-boost converter to convert input voltage into a lower output voltage, the discharge rate of inductor L will be relatively faster than the charge rate of the inductor L and durations of states 426, 316 can be shorter than durations of state 435. Controller 110 can be configured to generate PWM control signals to control the duration of the turned on times (e.g., adjust duty cycle) of switches in switching circuits 102, 104 to control the charge rate and the discharge rate of inductor IL.

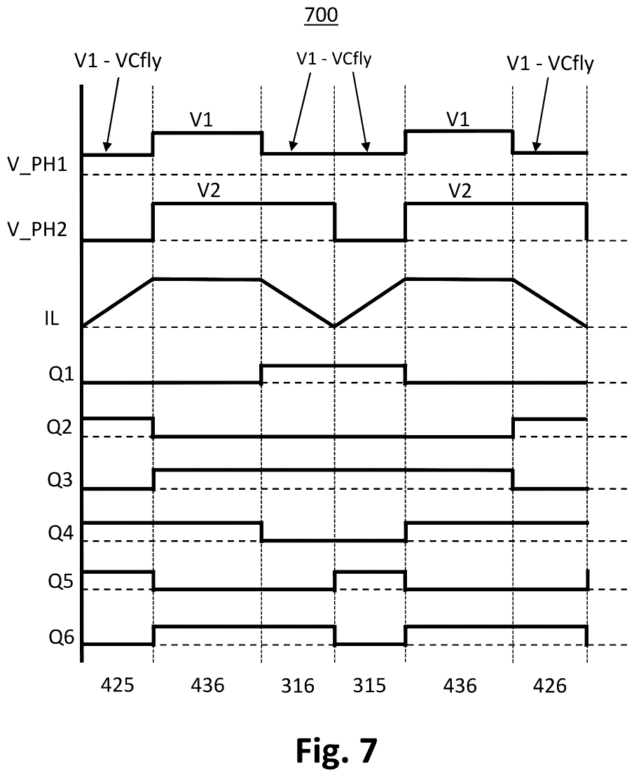

FIG. 7 is a diagram showing another set of signal waveforms of bidirectional three-level buck-boost voltage converter with battery charging in one embodiment. Description of FIG. 2 can reference components shown in FIG. 1 to FIG. 6. A set of signal waveforms showing a switching sequence 700 performed by controller 110 to control circuit 101 is shown in FIG. 7. Switching sequence 700 can be performed under an operation mode where circuit 101 operates as a buck-boost voltage converter to convert V1 into another voltage V2. In one embodiment, operation mode 106 can indicate a three-level buck-boost voltage converter with reduced switching frequency and controller 110 can generate control signals 112, 114 having PWM signals that vary according to switching sequence 700. In the example shown in FIG. 7, V1 can be input voltage and V2 can be the output voltage such that the inductor current IL can flow from PH1 to PH2. Controller 110 can perform switching sequence 700 repetitively by turning on state 425, state 436, state 316 then state 315, then state 436, then state 426. In the example shown in FIG. 7, switching sequence 700 can introduce a plateau on IL (e.g., maintain IL at a constant level) to lower switching frequency. The lowered switching frequency can reduce switching loss and maintain efficiency. Controller 110 can be configured to generate PWM control signals to control the duration of the turned on times (e.g., adjust duty cycle) of switches in switching circuits 102, 104 to control the charge rate and the discharge rate of inductor IL and to control a duration of IL being maintained at a constant level.

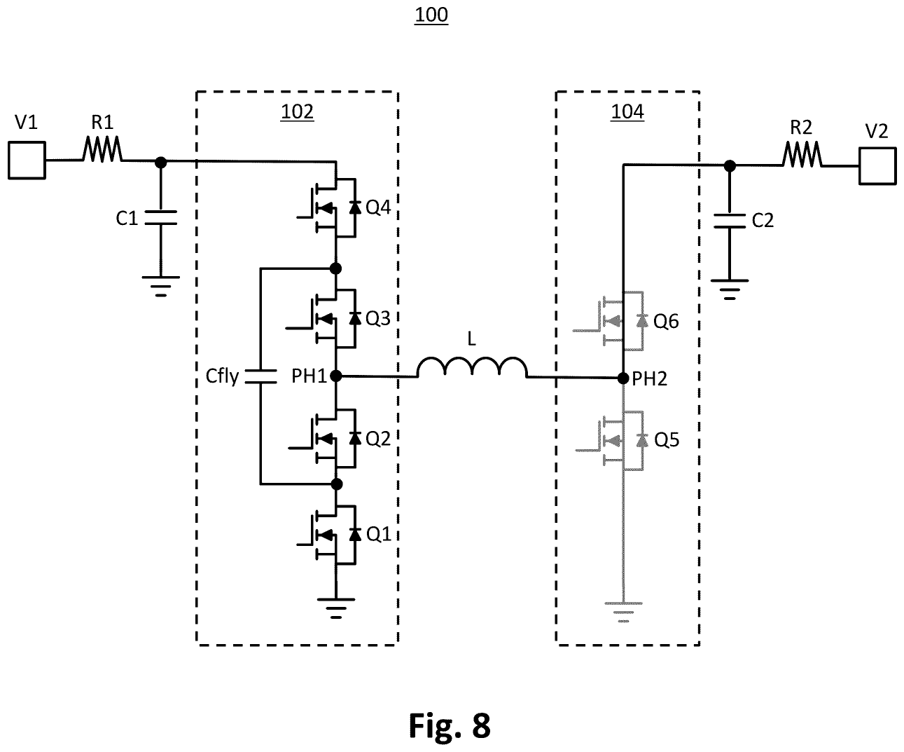

FIG. 8 is a diagram showing a configuration of bidirectional three-level buck-boost voltage converter with battery charging in one embodiment. In one or more embodiments, circuit 101 can be constructed to have one or more components, such as switches, in do not populate (DNP) state (herein referred as “DNP component”). When a component of circuit 101 is in the DNP state, the component may not be installed or placed on a printed circuit board (PCB) that holds circuit 101. In some aspects, circuit 101 can be printed on a PCB with spaces or footprints on the PCB being preserved for future components, such as the DNP components. In some aspects, different applications can use different components of circuit 101. DNP components not within the design specs of a specific application can be removed from a manufacturing process of circuit 101, thus saving costs and PCB footprint. In some aspects, circuit 101 can be printed on a PCB without installing or placing the DNP components for testing and debugging purposes.

In the example embodiment shown in FIG. 8, switches Q5 and Q6 can be DNP components. When switches Q5 and Q6 are DNP components (shown as gray components), circuit 101 can have a 4-FET configuration where switches Q1, Q2, Q3, Q4 can be installed on circuit 101. In the embodiment shown in FIG. 8, controller 110 can control switches Q1, Q2, Q3, Q4 under a switching sequence that can operate circuit 101 as a bidirectional buck converter without isolation. While switches Q5 and Q6 are DNP components, controller 110 can operate circuit 101 as bidirectional buck converter, without isolation, without modifications to controller 110.

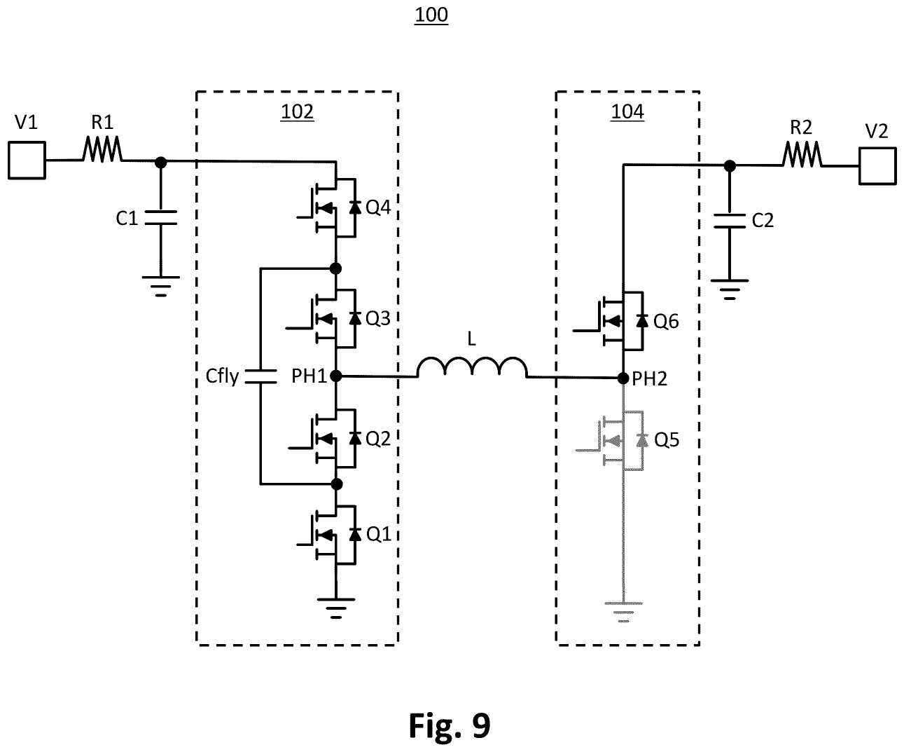

FIG. 9 is a diagram showing another configuration of bidirectional three-level buck-boost voltage converter with battery charging in one embodiment. In the example embodiment shown in FIG. 9, switch Q5 can be a DNP component (shown as gray component) and switch Q6 can be used as an isolation field effect transistor (FET) to electrically isolate a device connected to or providing V1 from a device connected to or providing V2. When switch Q5 is a DNP component, circuit 101 can have a 5-FET configuration where switches Q1, Q2, Q3, Q4, Q6 can be installed on circuit 101. In the embodiment shown in FIG. 9, controller 110 can control switches Q1, Q2, Q3, Q4, under a switching sequence that can operate circuit 101 as a bidirectional buck converter with isolation. While switches Q5 is a DNP component, controller 110 can operate circuit 101 as bidirectional buck converter, with isolation, without modifications to controller 110.

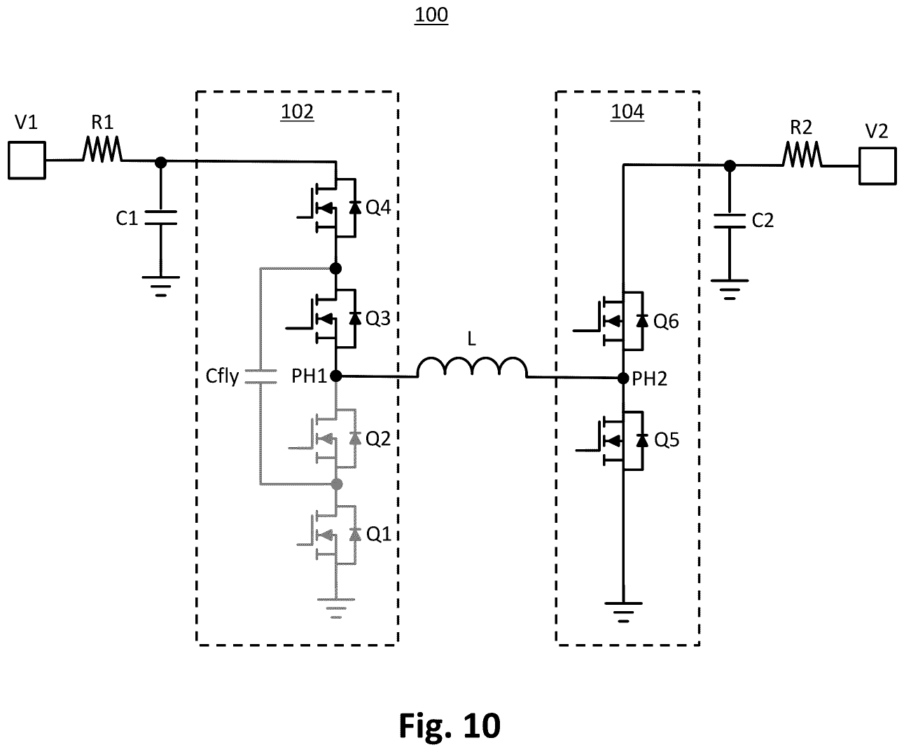

FIG. 10 is a diagram showing another configuration of bidirectional three-level buck-boost voltage converter with battery charging in one embodiment. In the example embodiment shown in FIG. 10, switches Q1, Q2 can be DNP components (shown as gray components) and switches Q3, Q4 can be used as isolation FETs to electrically isolate a device connected to or providing V1 from a device connected to or providing V2. When switches Q1, Q2 are DNP components, circuit 101 can have a 4-FET configuration where switches Q3, Q4, Q5 Q6 can be installed on circuit 101. In the embodiment shown in FIG. 10, controller 110 can control switches Q5, Q6, under a switching sequence that can operate circuit 101 as a bidirectional boost converter with isolation. While switches Q1 and Q2 are DNP components, controller 110 can operate circuit 101 as bidirectional boost converter, with isolation, without modifications to controller 110.

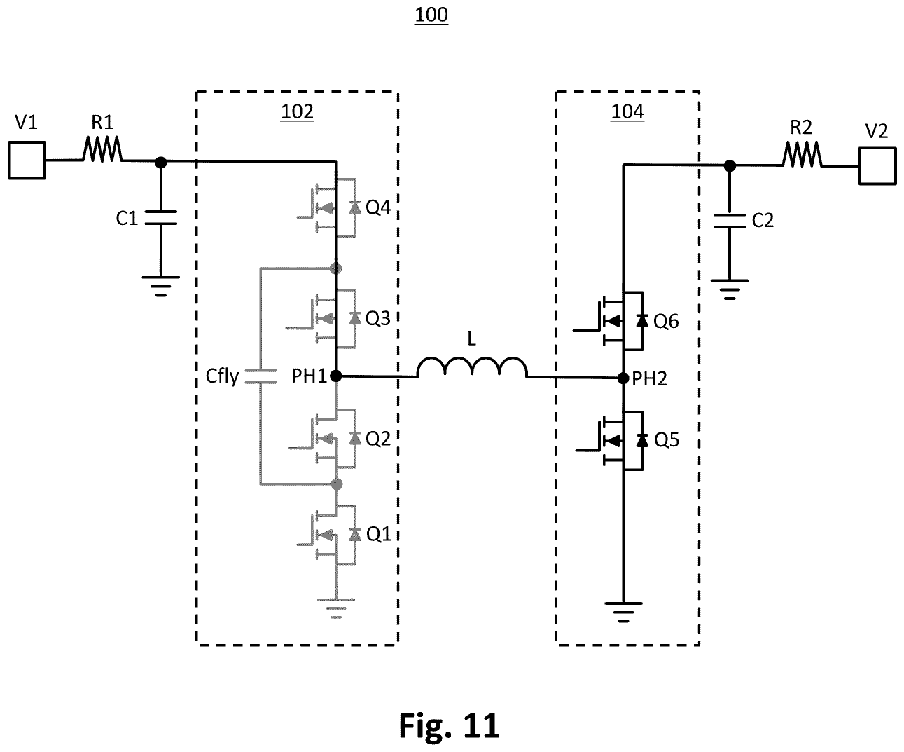

FIG. 11 is a diagram showing another configuration of bidirectional three-level buck-boost voltage converter with battery charging in one embodiment. In the example embodiment shown in FIG. 11, switches Q1, Q2, Q3, Q4 can be DNP components (shown as gray components). When switches Q1, Q2, Q3, Q4 are DNP components, circuit 101 can have a 2-FET configuration where switches Q5, Q6 can be installed on circuit 101. In the embodiment shown in FIG. 11, controller 110 can control switches Q5, Q6 under a switching sequence that can operate circuit 101 as a bidirectional boost converter without isolation. While switches Q1, Q2, Q3, Q4 are DNP components, controller 110 can operate circuit 101 as bidirectional boost converter, without isolation, without modifications to controller 110.

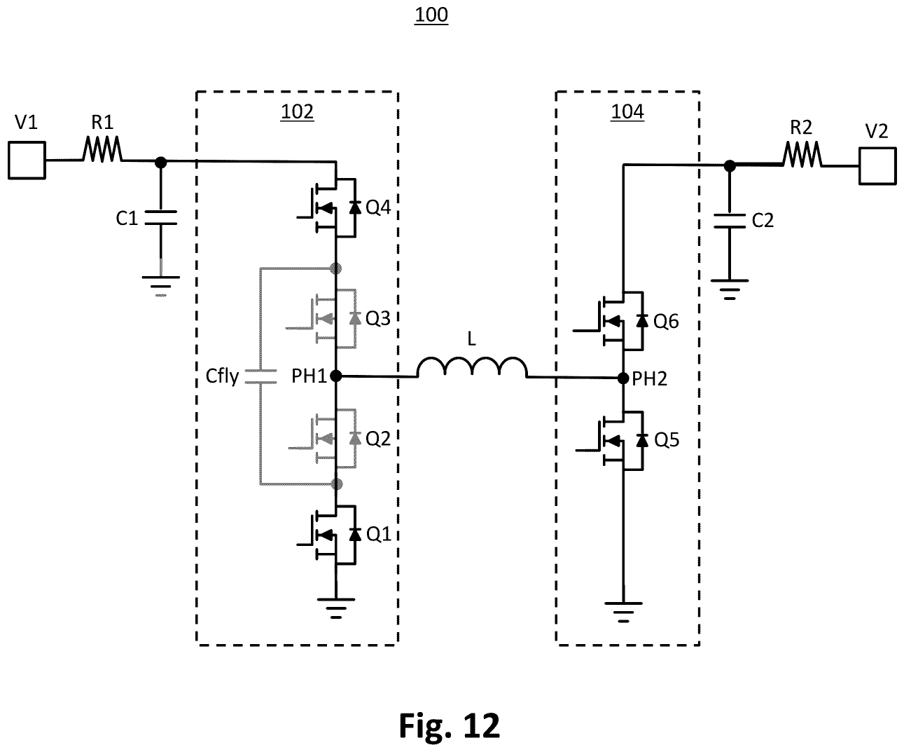

FIG. 12 is a diagram showing another configuration of bidirectional three-level buck-boost voltage converter with battery charging in one embodiment. In the example embodiment shown in FIG. 12, switches Q2, Q3 can be DNP components (shown as gray components). When switches Q2, Q3 are DNP components, circuit 101 can have a 4-FET configuration where switches Q1, Q4, Q5, Q6 can be installed on circuit 101. In the embodiment shown in FIG. 12, controller 110 can control switches Q1, Q4, Q5, Q6 under a switching sequence that can operate circuit 101 as a bidirectional two-level buck-boost converter. While switches Q2, Q3 are DNP components, controller 110 can operate circuit 101 as bidirectional two-level buck-boost converter without modifications to controller 110. Therefore, controller 110 can be configured to support both two-level and three-level voltage conversion and circuit 101 can be converted from a three-level buck-boost voltage converter to a two-level buck-boost converter by removing specific components.

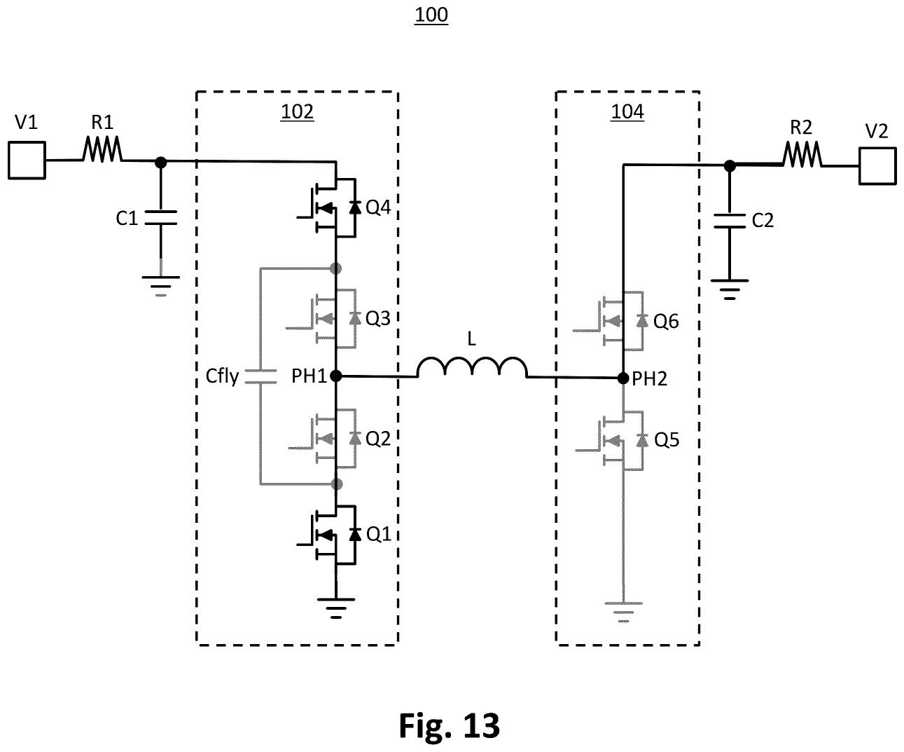

FIG. 13 is a diagram showing another configuration of bidirectional three-level buck-boost voltage converter with battery charging in one embodiment. In the example embodiment shown in FIG. 13, switches Q2, Q3, Q5, Q6 can be DNP components (shown as gray components). When switches Q2, Q3, Q5, Q6 are DNP components, circuit 101 can have a 2-FET configuration where switches Q1, Q4 can be installed on circuit 101. In the embodiment shown in FIG. 13, controller 110 can control switches Q1, Q4 under a switching sequence that can operate circuit 101 as a bidirectional two-level buck converter without isolation. While switches Q2, Q3, Q5, Q6 are DNP components, controller 110 can operate circuit 101 as bidirectional two-level buck converter, without isolation, without modifications to controller 110. Therefore, controller 110 can be configured to support both two-level and three-level voltage conversion and circuit 101 can be converted from a three-level buck-boost voltage converter to a two-level buck converter by removing specific components.

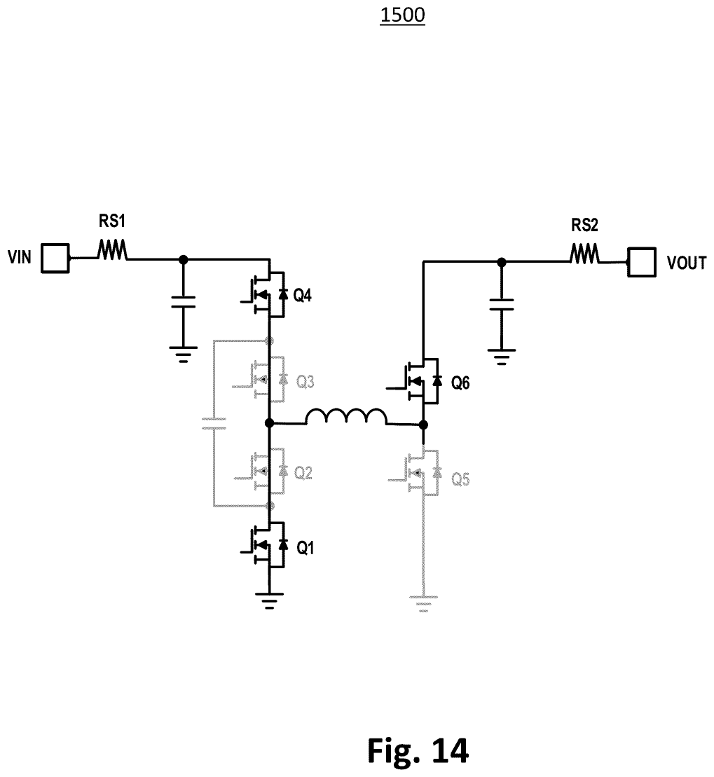

FIG. 14 is a diagram showing another configuration of bidirectional three-level buck-boost voltage converter with battery charging in one embodiment. In the example embodiment shown in FIG. 14, switches Q2, Q3, Q5 can be DNP components (shown as gray components). When switches Q2, Q3, Q5 are DNP components, circuit 101 can have a 3-FET configuration where switches Q1, Q4, Q6 can be installed on circuit 101. Switch Q6 can be operated as an isolation FET. In the embodiment shown in FIG. 14, controller 110 can control switches Q1, Q4 under a switching sequence that can operate circuit 101 as a bidirectional two-level buck converter with isolation. While switches Q2, Q3, Q5 are DNP components, controller 110 can operate circuit 101 as bidirectional two-level buck converter, with isolation, without modifications to controller 110. Therefore, controller 110 can be configured to support both two-level and three-level voltage conversion and circuit 101 can be converted from a three-level buck-boost voltage converter to a two-level buck converter by removing specific components.

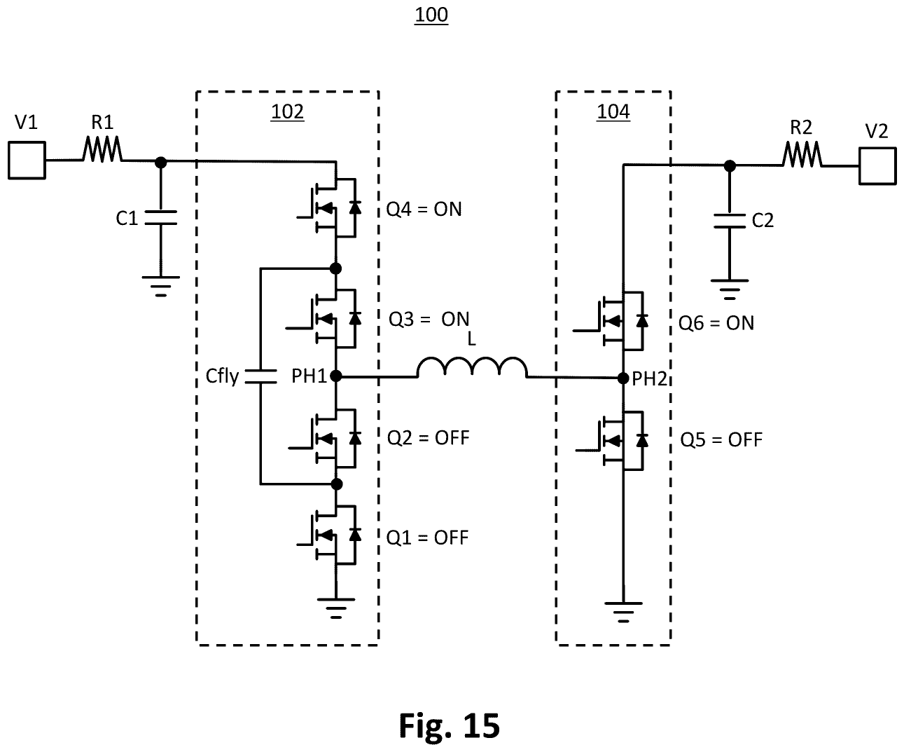

FIG. 15 is a diagram showing another configuration of bidirectional three-level buck-boost voltage converter with battery charging in one embodiment. In the example embodiment shown in FIG. 15, controller 110 can maintain switches Q1, Q2, Q5 in an off state and maintain switches Q3, Q4, Q6 in an on state to operate circuit 101 in a pass-through mode. In the pass through mode, voltage V1 and V2 can be equivalent and no switching is performed in circuit 101, hence the pass-through mode can reduce switching loss. In one embodiment, operation mode 106 can indicate a pass-through mode and controller 110 can generate control signals 112, 114 to turn off and maintain switches Q1, Q2, Q5 in an off state and to turn on and maintain switches Q3, Q4, Q6 in an on state.

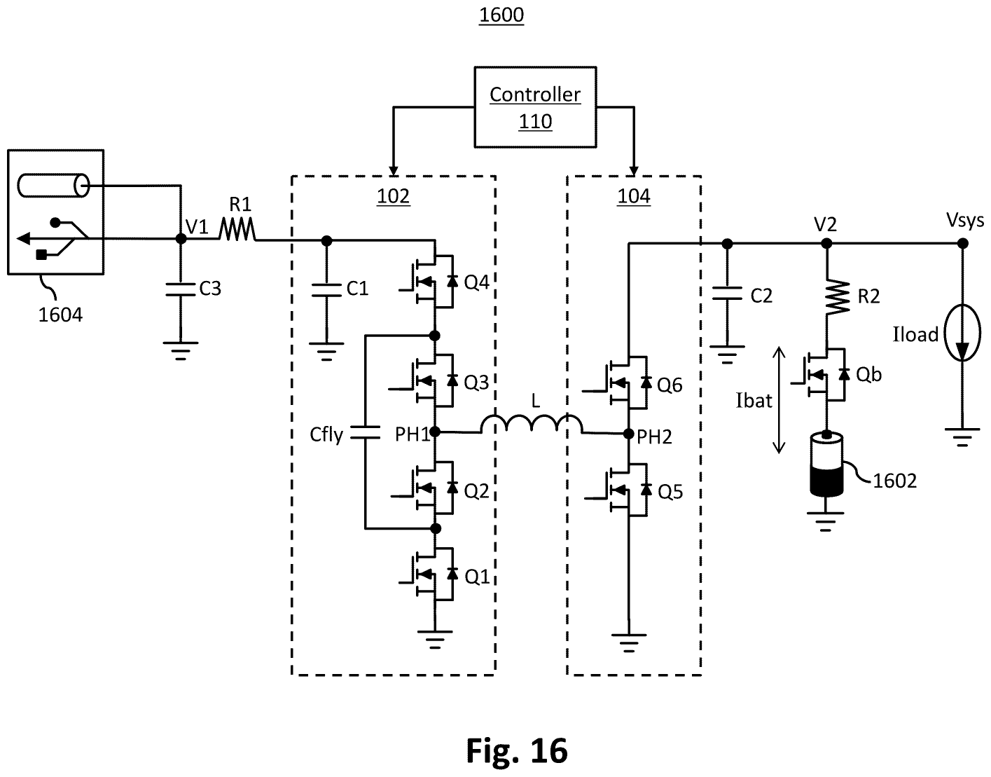

FIG. 16 is a diagram showing an example application of bidirectional three-level buck-boost voltage converter with battery charging in one embodiment. A system 1600 is shown in FIG. 16, where system 1600 can be a battery charging system. System 100, including circuit 101 and controller 110, can be a part of system 1600. A battery 1602 and a switch Qb can be connected to circuit 101. Switch Qb can be a FET that can be turned on or turned off by controller 110 to control charge or discharge of battery 1602. The resistor R2 can be repositioned as shown in FIG. 16 for sensing battery current Ibat that can include charging current or discharge current. A supply 1604 can also be connected to circuit 101. Supply 1604 can provide the voltage V1, or can receive voltage V1. Supply 1604 can be, for example, an adapter such as a barrel adapter, a universal serial bus (USB) adapter, or other power delivery components and systems that can supply voltage V1.

Battery 1602 can be charged by V1 being supplied by supply 1604, and can be discharged to supply Vsys and/or supply power to V1 as a result of bidirectional voltage conversion being performed by system 100 (circuit 101 and controller 110). Controller 110 can control circuit 101 and switch Qb to operate system 1600 in various modes. In one embodiment, controller 110 can operate circuit 101 to convert voltage V1 into V2, and controller 110 can turn on Qb, to power from supply 1604 to charge battery 1602 and/or to provide to the load drawing Iload. In one embodiment, controller 110 can control circuit 101 to operate system 1600 in a reverse mode where circuit 101 can convert voltage V2 into V1 to allow battery 1602 to provide power to a device or component that includes, or is connected to, supply 1604. In one embodiment, controller 110 can control circuit 101 to operate system 1600 in an on-the-go (OTG) mode where supply 1604 can be disconnected from circuit 101, controller 110 can turn off all switches in circuit 101, and battery 1602 can supply Vsys. The 6-FET topology of circuit 101 can allow controller 110 to operate circuit 101 to perform different types of voltage conversion to manage a battery charging system, such as system 1600.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The disclosed embodiments of the present invention have been presented for purposes of illustration and description but are not intended to be exhaustive or limited to the invention in the forms disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

What is claimed is:

1. A semiconductor device comprising:
a first switching circuit comprising four switches and a flying capacitor;
a second switching circuit comprising two switches; and
an inductor connected between a first phase node of the first switching circuit to a second phase node of the second switching converter, wherein the first switching circuit and the second switching circuit are combined to implement a buck-boost voltage converter that performs voltage conversion in a first direction from the first phase node to the second phase node and in a second direction from the second phase node to the first phase node.

2. The semiconductor device of claim 1, wherein:
the four switches comprises a first high-side (HS) switch, a second HS switch, a first low-side (LS) switch, and a second LS switch connected in series;
the first LS switch is connected between the second LS switch and ground;
the second LS switch is connected between the first phase node and the first LS switch;
the first HS switch is connected between the first phase node and the second HS switch;
the second HS switch is connected between the first HS switch and a first voltage interface;
the flying capacitor is connected across the second LS switch and the first HS switch;
the two switches comprises a third LS switch and a third HS switch;
the third LS switch is connected between the second phase node and ground; and
the third HS switch is connected between the second phase node and a second voltage interface.

3. The semiconductor device of claim 1, wherein:
a low-side switch in the second switching circuit is kept in an off state;
a high-side switch in the second switching circuit is kept in an on state; and
the first switching circuit operates as a three-level buck voltage converter.

4. The semiconductor device of claim 3, wherein:
the first switching circuit is switched under a first sequence to output a low voltage range; and
the first switching circuit is switched under a second sequence to output a high voltage range.

5. The semiconductor device of claim 1, wherein:
a first LS switch and a second LS switch in the first switching circuit are kept in an off state;
a first HS switch and a second HS switch in the first switching circuit are kept in an on state; and
the second switching circuit is switched under a specific sequence to operate as a two-level boost voltage converter.

6. The semiconductor device of claim 1, wherein:
a first LS switch and a second LS switch in the first switching circuit are kept in an off state;
a first HS switch and a second HS switch in the first switching circuit are kept in an on state;
a first LS switch in the second switching circuit is kept in an off state;
a first HS switch in the second switching circuit is kept in an on state; and
the first switching circuit and the second switching circuit operate in a pass through mode to pass voltage in one of the first direction and the second direction.

7. A system comprising:
a controller;
a circuit comprising:
a first switching circuit comprising four switches and a flying capacitor;
a second switching circuit comprising two switches; and
an inductor connected between a first phase node of the first switching circuit to a second phase node of the second switching converter,
wherein the controller being configured to operate the circuit as a buck-boost converter that performs voltage conversion in a first direction from the first phase node to the second phase node and in a second direction from the second phase node to the first phase node.

8. The system of claim 7, wherein:
the four switches comprises a first high-side (HS) switch, a second HS switch, a first low-side (LS) switch, and a second LS switch connected in series;
the first LS switch is connected between the second LS switch and ground;
the second LS switch is connected between the first phase node and the first LS switch;
the first HS switch is connected between the first phase node and the second HS switch;
the second HS switch is connected between the first HS switch and a first voltage interface;
the flying capacitor is connected across the second LS switch and the first HS switch;
the two switches comprises a third LS switch and a third HS switch;
the third LS switch is connected between the second phase node and ground; and
the third HS switch is connected between the second phase node and a second voltage interface.

9. The system of claim 7, wherein the controller is configured to:
maintain a low-side switch in the second switching circuit in an off state;
maintain a high-side switch in the second switching circuit in an on state; and
operate the circuit as a three-level buck voltage converter.

10. The system of claim 9, wherein the controller is configured to:
switch the first switching circuit under a first sequence to output a low voltage range; and
switch the first switching circuit under a second sequence to output a high voltage range.

11. The system of claim 7, wherein the controller is configured to:
maintain a first LS switch and a second LS switch in the first switching circuit in an off state;
maintain a first HS switch and a second HS switch in the first switching circuit in an on state; and
operate the circuit as a two-level boost voltage converter.

12. The system of claim 7, wherein the controller is configured to:
maintain a first LS switch and a second LS switch in the first switching circuit in an off state;
maintain a first HS switch and a second HS switch in the first switching circuit in an on state;
maintain a first LS switch in the second switching circuit in an off state;
maintain a first HS switch in the second switching circuit in an on state; and
operate the circuit in a pass through mode to pass voltage in one of the first direction and the second direction.

13. The system of claim 7, wherein the controller is configured to control a charge rate and a discharge rate of the inductor to operate the circuit as a buck-boost voltage converter.

14. A system comprising:
a battery;
a controller; and
a circuit comprising:
a first switching circuit comprising four switches and a flying capacitor;
a second switching circuit comprising two switches; and
an inductor connected between a first phase node of the first switching circuit to a second phase node of the second switching converter,
the controller being configured to:
operate the circuit as a buck-boost converter that performs voltage conversion in a first direction from the first phase node to the second phase node to charge the battery; and
operate the circuit as a buck-boost converter that performs voltage conversion in a second direction from the second phase node to the first phase node to discharge the battery.

15. The system of claim 14, wherein:
the four switches comprises a first high-side (HS) switch, a second HS switch, a first low-side (LS) switch, and a second LS switch connected in series;
the first LS switch is connected between the second LS switch and ground;
the second LS switch is connected between the first phase node and the first LS switch;
the first HS switch is connected between the first phase node and the second HS switch;
the second HS switch is connected between the first HS switch and a first voltage interface;
the flying capacitor is connected across the second LS switch and the first HS switch;
the two switches comprises a third LS switch and a third HS switch;
the third LS switch is connected between the second phase node and ground; and
the third HS switch is connected between the second phase node and a second voltage interface.

16. The system of claim 14, wherein the controller is configured to:
maintain a low-side switch in the second switching circuit in an off state;
maintain a high-side switch in the second switching circuit in an on state; and
operate the circuit as a three-level buck voltage converter.

17. The system of claim 14, wherein the controller is configured to:
maintain a first LS switch and a second LS switch in the first switching circuit in an off state;
maintain a first HS switch and a second HS switch in the first switching circuit in an on state; and
operate the circuit as a two-level boost voltage converter.

18. The system of claim 14, wherein the controller is configured to:
maintain a first LS switch and a second LS switch in the first switching circuit in an off state;
maintain a first HS switch and a second HS switch in the first switching circuit in an on state;
maintain a first LS switch in the second switching circuit in an off state;
maintain a first HS switch in the second switching circuit in an on state; and
operate the circuit in a pass through mode to pass voltage in the first direction to charge the battery.

19. The system of claim 14, further comprising a load, wherein the controller is configured to turn off the four switches in the first switching circuit and turn off the two switches in the second switching circuit to discharge the battery to the load under an on-the-go (OTG) mode.

20. The system of claim 16, wherein the controller is configured to control a charge rate and a discharge rate of the inductor to operate the circuit as a buck-boost voltage converter.
